(19) United States
(12) Patent Application Publication
(10) Pub. No.: US 2013/0085784 A1
(43) Pub. Date: Apr. 4, 2013

(54) USING A PAYMENT CARD TO ELECTRONICALLY ADJUDICATE CLAIMS FROM PATIENTS UTILIZING MAJOR MEDICAL BENEFITS FOR PRESCRIPTION DRUGS AND SERVICES

(71) Applicant: Dana A. Kuhn, Midlothian, VA (US)

(72) Inventor: Dana A. Kuhn, Midlothian, VA (US)

(21) Appl. No.: 13/623,571

(22) Filed: Sep. 20, 2012

Related U.S. Application Data
(60) Provisional application No. 61/541,838, filed on Sep. 30, 2011.

(51) Int. Cl. G06Q 50/24

(52) U.S. Cl. 705/4

(57) ABSTRACT

Processing a major medical claim in at least one processor. Receiving a major medical claim. Preparing a claim order from the received major medical claim. Transmitting the prepared claim order to a primary payer. Receiving a response to the transmitted claim order, the response comprising the amount of primary coverage. Transmitting claim order information and the amount of primary coverage to a secondary payer.

### CROSS-REFERENCE TO RELATED APPLICATIONS

The present application claims priority to and incorporates by the reference in the entirety U.S. Prov. Pat. App. No. 61/541,838, filed Sep. 30, 2011.

### BACKGROUND

Medicare is a national social insurance program, administered by the U.S. federal government since 1965, which guarantees access to health insurance for Americans 65 years old and older, along with younger people with disabilities and people with end-stage renal disease. Medicare offers enrollees a defined benefit. Hospital care is covered under Part A, and outpatient medical services are covered under Part B. To cover the Part A and Part B benefits, Medicare offers a choice between an open-network single payer health care plan (traditional Medicare) and a network plan (Medicare Advantage, or Medicare Part C), where the federal government pays for private health coverage. Prescription drug benefits are available under Part D.

“Claims adjudication” in the insurance industry refers to the process of paying claims submitted or denying. them after comparing claims to the benefit or coverage requirements. The adjudication process consists of receiving a claim from an insured person and then utilizing software to process the claims and make a decision or doing so manually. At the end of the claims adjudication process, the insurer may inform the insured of the outcome, typically in a letter sometimes referred to as remittance advice. A remittance advice may include a statement as to whether the claim was denied or approved. The insurer may send an explanation of benefits that includes detailed information about how each service included in the claim was settled. The insurer may then pay the provider(s) the approved amount.

### SUMMARY

The technology includes processes, computer program products, and systems for processing a major medical claim in at least one processor. Embodiments include receiving a major medical claim, and preparing a claim order from the received major medical claim. The prepared claim order is then transmitted to a primary payer. A response to the transmitted claim order is received from the primary payer, the response including at least the amount of primary coverage. The claim order information and the amount of primary coverage are then transmitted to a secondary payer.

in sonic embodiments, the major medical claim is a claim under at least one of government insurance program, e.g., Medicare Part A, or Medicare Part B. In some embodiments, transmitting the prepared claim order to a primary payer includes transmitting the prepared claim order to a clearinghouse, and the clearinghouse forwarding the prepared claim order to the primary payer. In some embodiments, transmitting claim order information and the amount of primary coverage to a secondary payer includes, transmitting the claim order information and amount of primary coverage to a clearinghouse, and the clearinghouse forwarding the claim information and the amount of primary coverage to the secondary payer.

Some embodiments further include first adjudicating the transmitted claim order. In such embodiments, receiving as response to the transmitted claim order includes receiving a response to the first adjudicated claim order. Some embodiments further include second adjudicating the transmitted claim information and amount of primary coverage. In some embodiments, the major medical claim is for at least one of a product and a service provided by a medical provider; and the medical provider is paid less than or equal to the amount of the claim minus the amount of the primary coverage.

### DESCRIPTION OF THE DRAWINGS

The accompanying drawings, which are included to provide a further understanding of the present technology, are incorporated in and constitute a part of this specification, illustrate embodiments of the present technology and together with the detailed description serve to explain the principles of the present technology. No attempt is made to show structural details of the present technology in more detail than may be necessary for a fundamental understanding of the present technology and the various was in which it may be practiced.

FIG. 1 illustrates the complete lifecycle of the process, starting with the patient applying for assistance and ending with a cycle in which secondary payments are made.

FIG. 2 illustrates a greater level detail of the process required for the provider to submit a claim using the present technology.

### DETAILED DESCRIPTION

The embodiments of the present technology and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the present technology. The examples used herein are intended merely to facilitate an understanding of ways in which the present technology may be practiced and to further enable those of skill in the art to practice the embodiments of the present technology. Accordingly, the examples and embodiments herein should not be construed as limiting the scope of the present technology, which is defined solely by the appended claims and applicable law. Moreover, it is noted that like reference numerals represent similar parts throughout the several views of the drawings.

### Problem

The United States government, through the initial Medicare Modernization Act of 2003 has embraced the claim adjudication process of the National Council for Prescription Drug Programs (NCPDP) for its Medicare Part D (prescription drug plan) program. Medicare Part A (hospital insurance) and Medicare Part B (medical insurance) may be considered major medical claims, and standardized electronic processes for billing and payment do not exist. There are medical procedures, prescription drugs, and therapies under Medicare Part A and/or Medicare Part B that by nature of their controlled administration may require a specialized billing code and process due to involving suites of administration or services, thus not easily adaptable to the NCPDP model of standardization for pharmacy benefits.

There is a process that exists in the corporate world involving Electronic Data Interchange (EDI) for placing orders. However, there is not a business process for this to be adapted to the healthcare system—specifically major medical billing. This process provides simple and direct transmission of the information for direct transactions. The efficiency of this process may reduce the relatively large cost, seventy dollars ($70), of manually processing a paper-based order to as much smaller cost, e.g., one dollar ($1.00), utilizing the EDI system.

The EDI process works when a buyer prepares a purchasing order and then translates the order into an EDI document format known as an 850 purchase order. The EDI 850 purchase order is then securely transmitted to the supplier either h internet or through VAN (Value Added Network-binary formats). An important aspect is that the transaction is sent securely and reliably using passwords, user identification and encryption methods. Once the order is transmitted the supplier's computer system then processes the order. However, such an EDI system has never been adapted to and applied to healthcare systems, including major medical billing, which may involve complex transactions including multiple payers, providers and insurers within one transaction.

The present technology is directed at least in part, to addressing the needs of both publicly and privately insured beneficiaries (including those using infused drugs), who cannot have their major medical claims adjudicated electronically in a timely manner. Embodiments of the present technology address one or more of the following problems: 1) providers evading service to patients due to “bill and pay” issues and due to the hesitancy of the provider to buy the drug and hold on the shelve only to not have the patient use it because they cannot afford the copayment (challenge to physician often referred to as “buy and bill”); 2) hesitancy of beneficiaries to adhere to therapy due to embarrassment of unpaid clinic bills, thus causing greater expenses to Medicare through more expensive paid hospitalizations; 3) harassment of beneficiaries by bill collection agencies with unpaid copayments due to delayed billing and payment; and 4) physician incurred costs in hiring agencies to process paper claims (e.g., HCFA 1500; UB92 forms. Embodiments of the present technology can facilitate financial wholeness to providers deferring increased healthcare costs.

Major medical billing is antiquated in comparison to the adjudication process provided for Pharmacy Benefits Manager (PBM) entities. PBMs are third party administrators of prescription drug programs whereby they are primarily responsible for processing and paying prescription drug claims, e.g., claims under Medicare Part D. They also are responsible for developing and maintaining the drug formulary, contracting with pharmacies, and negotiating discounts and rebates with drug manufacturers. All this is done through an adjudication process overseen by the National Council for Prescription Drug Programs (NCPDP) which standardizes the transfer of data related to medications, supplies and services within the healthcare system. The major medical providers do not have a similar standardized process for handling major medical claims, thus creating the need for the present technology. The present technology can provide a more industry-efficient, cost-saving, and patient-beneficial system in comparison to the present antiquated adjudication process of major medical claims.

Embodiments of the present technology address the foregoing needs at least in part because it can provide assistance to patients, can help providers to receive payment with certainty, and does not interfere with the primary insurer's ability to conduct business. Moreover, the current process can require months for processing due to manual data entry, routing, and mailing of the forms and remittance. Embodiments of the present technology have the capability of reducing the processing time to a matter of minutes. The present technology adapting the EDI process to a healthcare system can work through major medical providers acting as buyers creating purchase orders. The present technology provides means for payment of the portion of a valid major medical claim not paid for by a primary insurer. In some embodiments, some or all of the present technology can be implemented by a non-profit organization. U.S. Pat. No. 7,805,318, “Using a Non-Profit Organization to Satisfy Medicare Out-Of-Pocket/TROOP and Product Replacement” describes a non-profit-implemented business process and system that can be practiced by such an organization to meet unserved Medicare Part D needs. That patent is hereby incorporated herein by reference in its entirety.

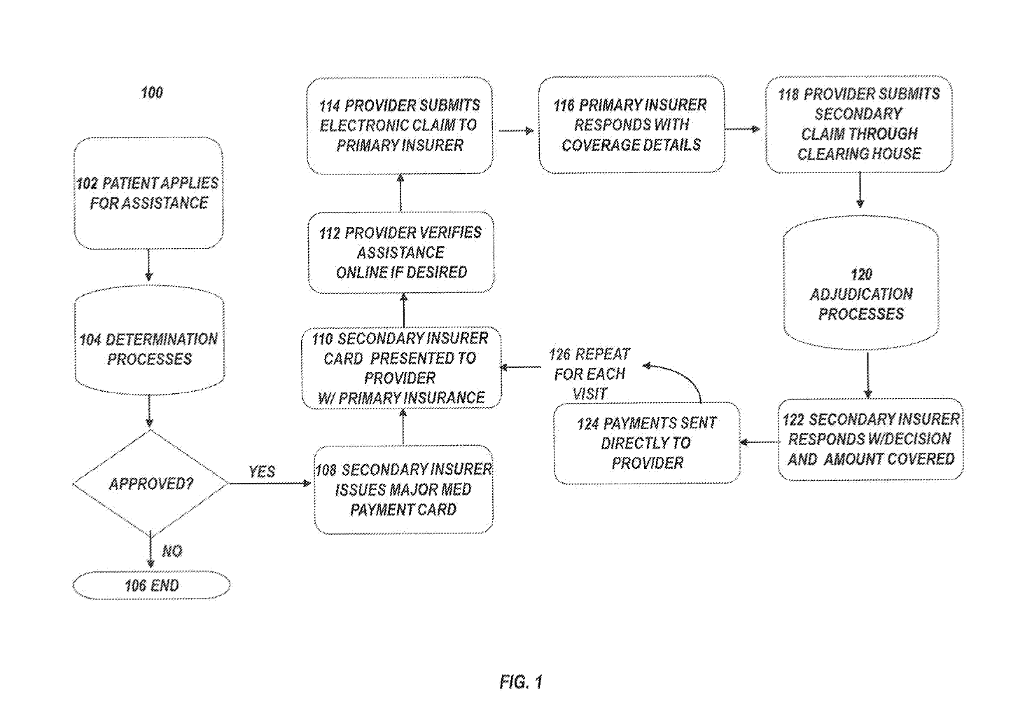

Referring to FIG. 1, an overview of a process 100 in accordance with embodiments of the present technology is shown in the context of a non-profit organization as the secondary insurer. After a patient applies 102 for assistance, e.g., directly or through referral, the non-profit determine eligibility 104 of the patient for secondary coverage. If the patient is not approved, then the process ends 106. If the patient is approved for secondary coverage, the non-profit (the secondary insurer) establishes an account for the approved patient, e.g., issues a major medical secondary payment card 108. Upon receiving treatment from a provider, the approved patient can present information on both primary insurance, and secondary insurance to the provider 110, e.g., the approved patient can present the secondary insurer card to the provider along with primary insurance information. In some embodiments of the present technology, the provider can verify the patient's enrollment in secondary insurance online 112. The provider can then submit an electronic claim to the primary insurer 114. The primary insurer can perform its own adjudication and respond with coverage details to the provider 116. The provider, now armed with coverage details (including the amount of primary coverage), can submit a claim for secondary coverage, e.g., through a clearinghouse 118. The secondary insurer, here a non-profit organization such as the non-profit organization described in U.S. Pat. No. 7,805,318, can perform its own adjudication 120, and respond to the provider (in some embodiments via the clearinghouse, in some embodiments to the patient) with the details of secondary coverage 122. The secondary insurer can then send secondary payment to the provider 124. This approach can be repeated for each visit 126.

While FIG. 1 presents the step in a particular sequence for ease of illustration of the principles of the technology, the steps can be performed in other sequences, e.g.: no clearinghouse can be used, claims for both primary and secondary coverage can be submitted by a provider at the same time to a clearinghouse and the clearinghouse can coordinate adjudication between primary and secondary insurers; the secondary insurer can concurrently respond to multiple parties with a secondary coverage decision and concurrently pay the provider.

Major medical providers would process the HCFA 1500 and UB92 claim forms electronically through their computer software systems thus generating a comparable 850 purchase order which we will call a claim order. This claim order is then sent, in some embodiments via a clearinghouse, to the primary payer (Medicare or commercial insurance company) for adjudication. Upon acceptance, the primary payer will respond electronically to the claim and send information indicating the amount of coverage and remaining balance to be paid by the patient. Subsequently, the clearing house will send notice to the secondary payer (PSI) indicating the services performed and the remaining balance for those services. The secondary payer will adjudicate the claim through an automated proprietary system built specifically for such a purpose. The primary insurer is then responsible for sending payment to the provider for the amount of insured coverage, and the secondary payer is responsible for the remaining balance after adjudication. The provider is made whole through a combination of the two payments, both of which are tracked electronically through the system.

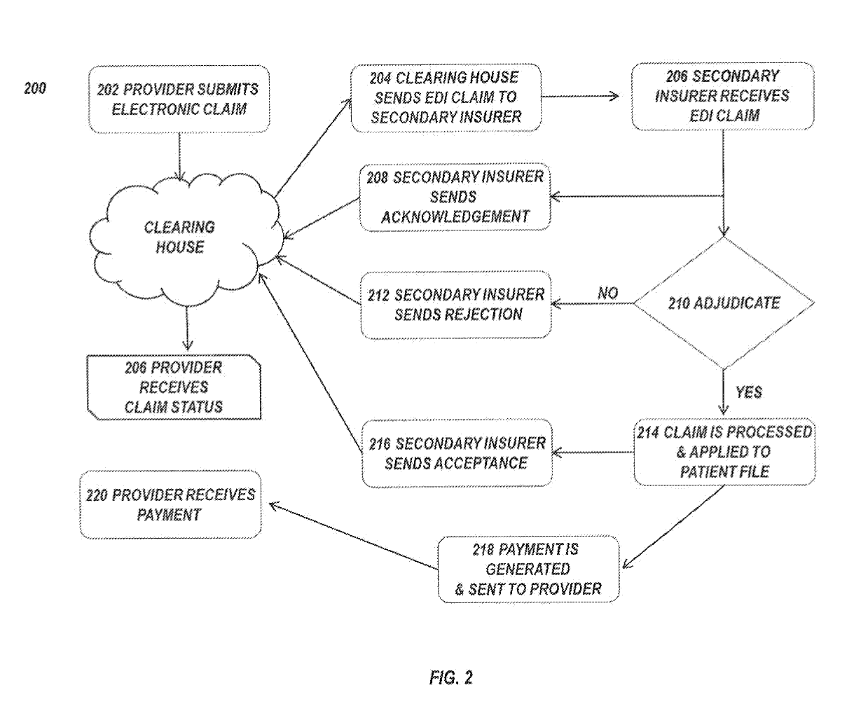

Referring to FIG. 2, an alternate view of a process 200 in accordance with embodiments of the present technology is shown in the context of a non-profit organization as the secondary insurer. After a provider submits an EDI claim 202 to a clearinghouse for services rendered to a patient who presents secondary insurance coverage information, the clearinghouse can send the claim to the secondary insurer 204. Upon receiving the claim from the clearinghouse 206, the secondary insurer can) acknowledge receipt of the claim 208, and adjudicate the claim 210. for claims that do not meet adjudication criteria, the secondary insurer can send a rejection via the clearinghouse 212. Claims that do meet the adjudication criteria are processes and applied to the patient file 214. For claims that are processed and applied to the patient file, the secondary insurer can send an acceptance to the clearinghouse 216, and can generate/send a payment 218, that can be received by the provider 220 that submitted the EDI claim.

It will be apparent to those skilled in the art that one or more aspects and functions of the present technology may be implemented on one or more computers. Such computers may include, but are not limited to, general purpose desktop computers, application specific computers, servers, and any other processor that may perform the necessary tasks. By way of example, and without limitation, one or more of the proprietary determination, approval, claim submission, claim response, and proprietary adjudication steps in FIG. 1 may be performed on one or more computers. Further, by way of example, and without limitation, one or more of the primary payer claim adjudication and response, primary payer payment, claim submission, clearinghouse, secondary payer claim adjudication and response, and secondary payer payment, steps in FIG. 1 may be performed on one or more computers. Such computers may also be configured within one or more networks that permit the transmission of information from at least one device to another device. Multiple networks may be interconnected to allow information to be electronically transferred directly from one network to the other. Alternatively, such networks may be kept separate so that information is transferred by other means, such as physical data input, loading data from a computer storage medium (e.g., DVD, hard drive, etc.) or the like.

It will be apparent to those skilled in the art that one or more aspects and functions of the present technology may be implemented using code for causing a processor or computer to perform the steps. Codes may be present on the computer or processor. Alternatively, the code may be stored on a computer readable medium (e.g., DVD, hard drive, etc.) and loaded onto one or more computers or processors.

While the invention has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications or modifications of the invention.

We claim:

1. A process for a major medical claim, the process comprising:
in at least one processor:
receiving a major medical claim;
preparing a claim order from the received major medical claim;
transmitting the prepared claim order to a primary payer;
receiving a response to the transmitted claim order, the response comprising the amount of primary coverage;
transmitting claim order information and the amount of primary coverage to a secondary payer.

2. The process of claim 1, wherein:
the major medical is a claim under at least one of government insurance program.

3. The process of claim 1, wherein:
the government insurance program is at least one of Medicare Part A and Medicare Part B.

4. The process of claim 1, wherein:
transmitting the prepared claim order to a primary payer comprises transmitting the prepared claim order to a clearinghouse, the clearinghouse forwarding the prepared claim order to the primary payer.

5. The process of claim 1, wherein:
transmitting claim order information and the amount of primary coverage to a secondary payer comprises transmitting the claim order information and amount of primary coverage to a clearinghouse, the clearinghouse forwarding the claim information and the amount of primary coverage to the secondary payer.

6. The process of claim 1:
further comprising first adjudicating the transmitted claim order; and
wherein, receiving a response to the transmitted claim order comprises receiving a response to the first adjudicated claim order.

7. The process of claim 1:
further comprising second adjudicating the transmitted claim information and amount of primary coverage.

8. The process of claim 1:
wherein the major medical claim is for at least one of a product and a service provided by a medical provider; and
further comprising paying the medical provider less than or equal to the amount of the claim minus the amount of the primary coverage.

9. A computer program product for processing a major medical claim, the computer program product comprising:
non-transitory computer-readable media storing instructions that when executed by at least one processor, are operative for:
receiving a major medical claim;
preparing a claim order from the received major medical claim;
transmitting the prepared claim order to a primary payer;
receiving a response to the transmitted claim order, the response comprising the amount of primary coverage;
transmitting claim order information and the amount of primary coverage to a secondary payer.

10. The computer program product of claim 9, wherein:
the major medical claim is a claim under at least one of government insurance program.

11. The computer program product of claim 9, wherein:
the government insurance program is at least one of Medicare Part A and Medicare Part B.

12. The computer program product of claim 9, wherein:
transmitting the prepared claim order to a primary payer comprises transmitting the prepared claim order to a clearinghouse, the clearinghouse forwarding the prepared claim order to the primary payer.

13. The computer program product of claim 9, wherein:
transmitting claim order information and the amount of primary coverage to a secondary payer comprises transmitting the claim order information and amount of primary coverage to a clearinghouse, the clearinghouse forwarding the claim information and the amount of primary coverage to the secondary payer.

14. The computer program product of claim 9:
further comprising, first adjudicating the transmitted claim order; and
wherein, receiving a response to the transmitted claim order comprises receiving a response to the first adjudicated claim order.

15. The computer program product of claim 9:
further comprising second adjudicating the transmitted claim information and amount of primary coverage.

16. The computer program product of claim 9:
wherein the major medical claim is for at least one of a product and a service provided by a medical provider; and
further comprising paying the medical provider less than or equal to the amount of the claim minus the amount of the primary coverage.

17. A system for processing a major medical claim, the system comprising:
at least one processor; and
a computer program product comprising:
non-transitory computer-readable media storing instructions that when executed by the at least one processor, are operative for
receiving a major medical claim;
preparing a claim order from the received major medical claim;
transmitting the prepared claim order to a primary payer;
receiving a response to the transmitted claim order, the response comprising the amount of primary coverage;
transmitting claim order information and the amount of primary coverage to a secondary payer.

18. The system of claim 17, wherein:
the major medical claim is a claim under at least one of government insurance program.

19. The system of claim 17, wherein:
the government insurance program is at least one of Medicare Part A and Medicare Part B.

20. The system of claim 17, wherein:
transmitting the prepared claim order to a primary payer comprises transmitting the prepared claim order to a clearinghouse, the clearinghouse forwarding the prepared claim order to the primary payer.

21. The system of claim 17, wherein:
transmitting claim order information and the amount of primary coverage to a secondary payer comprises transmitting the claim order information and amount of primary coverage to a clearinghouse, the clearinghouse forwarding, the claim information and the amount of primary coverage to the secondary payer.

22. The system of claim 17:
further comprising first adjudicating the transmitted claim order; and
wherein, receiving a response to the transmitted claim order comprises receiving a response to the first adjudicated claim order.

23. The system of claim 17:
further comprising second adjudicating the transmitted claim information and amount of primary coverage.

24. The system of claim 17:
wherein the major medical claim is for at least one of a product and a service provided by a medical provider; and
further comprising paying the medical provider less than or equal to the amount of the claim minus the amount of the primary coverage.
